(19) United States
(12) Patent Application Publication
(10) Pub. No.: US 2013/0147933 A1
(43) Pub. Date: Jun. 13, 2013

(54) USER IMAGE INSERTION INTO A TEXT MESSAGE

(71) Applicant: Charles J. Kulas, San Francisco, CA (US)

(72) Inventor: Charles J. Kulas, San Francisco, CA (US)

(21) Appl. No.: 13/465,860

(22) Filed: May 7, 2012

Related U.S. Application Data
(60) Provisional application No. 61/569,161, filed on Dec. 9, 2011.

(51) Int. Cl. H04N 7/18

(52) U.S. Cl. 348/61; 348/E07.085

(57) ABSTRACT

Embodiments generally relate to including an image in association with a text message. In one embodiment, a method includes receiving a signal from the text input interface to create the text message, and receiving a signal from the user control to initiate face image capture. The method also includes providing an image of the user's face by using the camera in response to the signal from the user control. The method also includes defining an emoticon derived from the captured image, and generating an image indicator in association with the text message. The method also includes sending the text message with the associated image indicator so that when the text message is displayed on a recipient's device an emoticon is displayed in association with the text message.

### CROSS REFERENCES TO RELATED APPLICATIONS

This application claims priority from U.S. Provisional Patent Application Ser. No. 61/569,161, entitled “USER IMAGE INSERTION INTO TEXT MESSAGE”, filed on Dec. 9, 2011, which is hereby incorporated by reference as if set forth in full in this application for all purposes.

### SUMMARY

In one embodiment, a method includes receiving a signal from the text input interface to create the text message, and receiving a signal from the user control to initiate face image capture. The method also includes providing an image of the user's face by using the camera in response to the signal from the user control. The method also includes defining an emoticon derived from the captured image, and generating an image indicator in association with the text message. The method also includes sending the text message with the associated image indicator so that when the text message is displayed on a recipient's device an emoticon is displayed in association with the text message.

### BRIEF DESCRIPTION OF THE DRAWINGS

FIG. 1A illustrates a diagram of a phone being used by a user.

FIG. 1B illustrates a front-view diagram of the phone of FIG. 1A, according to one embodiment.

FIG. 2 illustrates a block diagram of a phone, which may be used to implement the embodiments described herein.

FIG. 3 illustrates an example simplified flow diagram for inserting an image of a user into a message, according to one embodiment.

FIG. 4 illustrates a front-view diagram of the phone of FIG. 1A displaying an image after being appended at a cursor location, according to one embodiment.

FIG. 5A illustrates a diagram of a phone being used by a recipient user.

FIG. 5B illustrates a front-view diagram of the phone of FIG. 5A displaying a message received from a sending user, according to one embodiment.

### DETAILED DESCRIPTION

Many users of conventional computing devices such as computers, tablets, phones, etc., can send text messages to each other using email, texting (e.g. via Short Message Service (SMS), Multimedia Message Service (MMS) or other protocols), tweets, notifications, posts or other forms of messaging. To enhance communication, users may insert “emoticons” into messages. An emoticon can be a facial expression that is pictorially represented by punctuation and letters that are typed in by a user in association with a part of a message. More recently, emoticons can also be shown by a graphic or illustration of a face. In some messaging applications, text emoticons may be automatically replaced with small corresponding cartoon images.

Emoticons are typically used to express a writer's mood, or to provide the tenor or temper of a statement. In this type of use, the emoticon is usually inserted at the end of one or a few sentences in a text message or email. Emoticons can change and improve the interpretation of plain text. For example, a user may insert a happy face to express a happy mood or a sad face to express a sad mood. These images are also referred to as emoticons.

Embodiments described herein enhance user interaction while users exchange messages by enable users to insert emoticons into messages. Such emoticons are images of the sending user. When a recipient user receives a message from the sending user, the received message may include one or more emoticons. As described in more detail below, in one embodiment, a phone receives an indication from a user to insert an image (e.g., an emoticon) into a message, where the image is an image of the user. The phone then obtains the image, whether by taking a photo or video of the user or by retrieving the image from memory. The phone then determines the location of the cursor in the message and then appends the image at the cursor location.

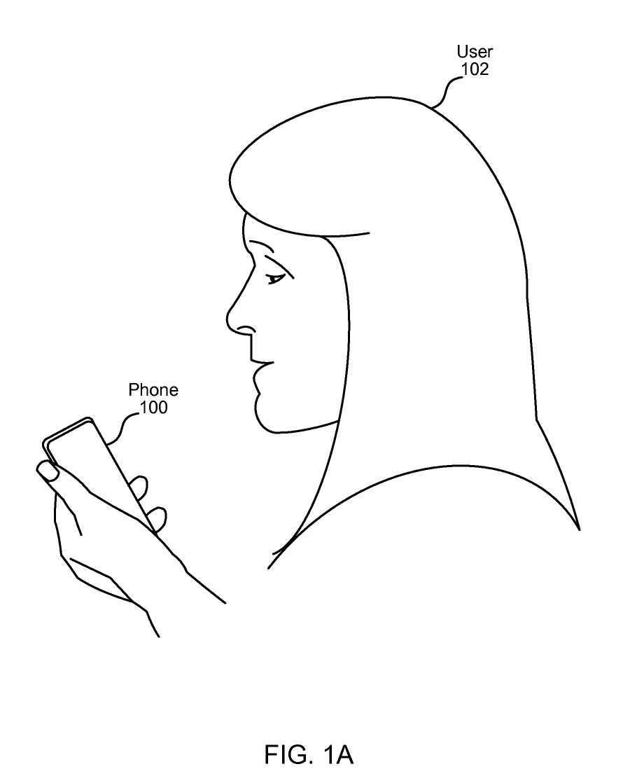

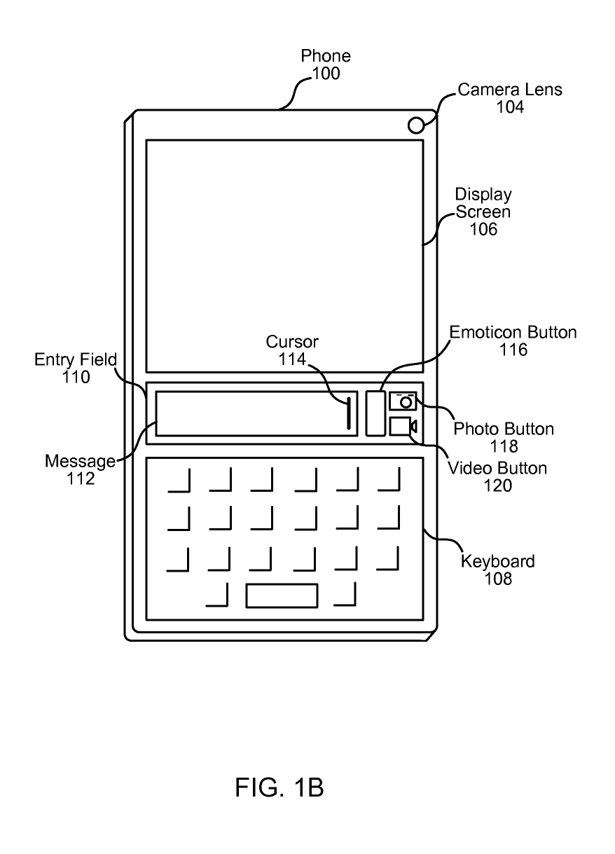

FIG. 1A illustrates a diagram of a phone 100 being used by a user 102. FIG. 1B illustrates a front-view diagram of phone 100, according to one embodiment. For ease of illustration, some embodiments are described herein in the context of a phone. Such embodiments and others described herein may also apply to any mobile device, where a mobile device may be a cell phone, personal digital assistant (PDA), tablet, etc. or any other handheld computing device.

In one embodiment, phone 100 also includes a camera lens 104 of a camera and includes a display screen 106. In one embodiment, display screen 106 is a touchscreen, which enables user 102 to control phone 100 with the touch of a finger or any other object (e.g., stylus, pencil, pen, etc.) that may be used to operate a touchscreen. In various embodiments, a graphical user interface (GUI) shown on display screen 106 displays a keyboard 108, an entry field 110 for entering a message 112, a cursor 114 to indicate where alphanumeric characters and symbols (e.g., emoticons, etc.) may be entered in entry field 110. The GUI also displays an emoticon button 116, a photo button 118, and a video button 120. In various embodiments, keyboard 108 and entry field 110 may be referred to as components of a text input interface.

For ease of illustration, emoticon button 116, photo button 118, and video button 120 are all shown together. Other embodiments are possible. For example, in one embodiment, phone 100 displays only emoticon button 116, and then displays photo button 118 and video button 120 after emoticon button is first pressed/touched. In various embodiments, emoticon button 116, photo button 118, and video button 120 may be referred to as control buttons or as user controls.

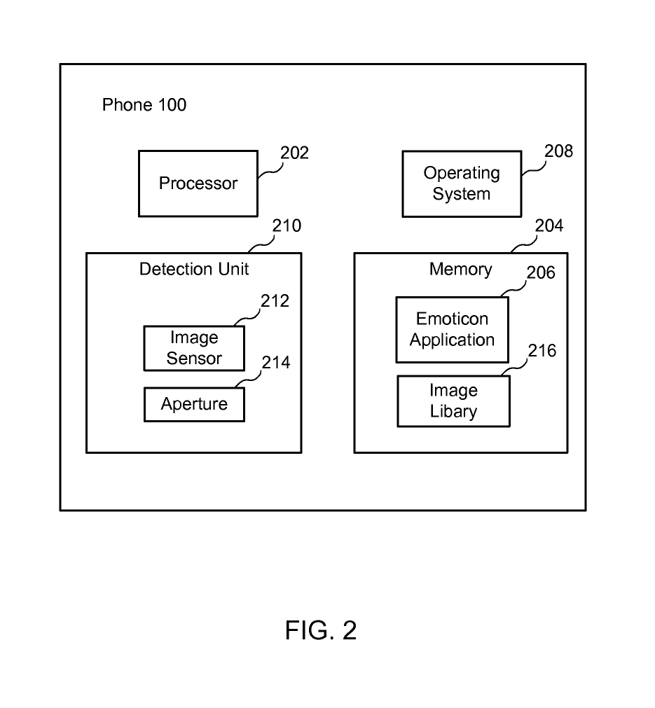

FIG. 2 illustrates a block diagram of phone 100, which may be used to implement the embodiments described herein. In one embodiment, phone 100 includes a processor 202 and a memory 204. In various embodiments, an emoticon application 206 may be stored on memory 204 or on any other suitable storage location or computer-readable medium. In one embodiment, memory 204 may be a non-volatile memory (e.g., random-access memory (RAM), flash memory, etc.). Emoticon application 206 provides instructions that enable processor 202 to perform the functions described herein. In one embodiment, processor 202 may include logic circuitry (not shown).

In one embodiment, phone 100 also includes a camera 210. In one embodiment, camera 210 may be a camera that includes an image sensor 212 and an aperture 214. Image sensor 212 captures images when image sensor 212 is exposed to light passing through camera lens 104 (FIG. 1B). Aperture 214 regulates light passing through camera lens 106. In one embodiment, after camera 210 captures images, camera 210 may store the images (e.g., photos and videos) in an image library 216 in memory 204.

In other embodiments, phone 100 may not have all of the components listed and/or may have other components instead of, or in addition to, those listed above.

The components of phone 100 shown in FIG. 2 may be implemented by one or more processors or any combination of hardware devices, as well as any combination of hardware, software, firmware, etc.

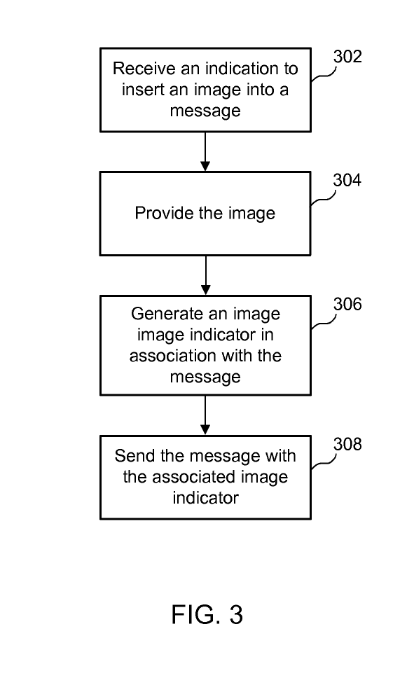

FIG. 3 illustrates an example simplified flow diagram for inserting an image such as an emoticon into a message, according to one embodiment. A method is initiated in block 302, where a system such as phone 100 or any mobile device receives an indication from a user to insert an image into a message. In one embodiment, the image is an image of the user. The image may also be referred to as an emoticon.

In one embodiment, the indication to insert an image into a message may include one or more other indications or signals. For example, in one embodiment, phone 100 may receive a signal from the text input interface to create a message such as a text message. For example, keyboard 108 may include a button such as a text message button that the user may select to initiate a text message. In one embodiment, phone 100 may receive a signal from a user control to initiate the capture of a face image capture. For example, in one embodiment, the user may select emoticon button 116 to initiate the capture of a face image. In various embodiments, the image may be a photo of the user or a video of the user. In various embodiments, the message into which the image is inserted may be an email message, a text message, a post entry, etc. In various embodiments, the user may compose the message by typing, by talking and using speech-to-text conversion, by gesturing and using gesture-to-text conversion, etc., or by using any other manner of input to create a message.

In block 304, phone 100 provides the image. For example, in one embodiment, phone 100 may obtain or capture an image of the user's face by using camera 210 in response to the signal from the user control. In one embodiment, phone 100 may obtain the image by using camera 210 to take a photo or video of the user. Phone 100 may also retrieve a stored image (e.g., from memory 204). Various embodiments for providing the image are described in more detail below.

In one embodiment, the user control used to trigger the capture of the image may be emoticon button 116. In various embodiments, the user control used to trigger the capture of the image may be any suitable GUI control (e.g., button, slider, etc.), swipe or gesture detection, in response to a motion or detection. For example, in one embodiment, phone 100 may detect user eyes pointing at camera and/or detecting the user changing and/or holding an expression for a predetermined time (e.g., a half a second, one second, etc.). The user control used to trigger the capture of the image may also be set to automatically perform a facial image capture upon the occurrence of the user typing a character such as a period and/or combination of a traditional smiley such as “:)”, or upon detection of entry of one or more characters.

In one embodiment, phone 100 may enable a voice command or other audible noise such as tongue clicking, kissing, etc., to trigger the capture of the image or to generate an emoticon in response to the sound. In one embodiment, phone 100 may enable sensors such as accelerometers, gyroscopes, etc., to trigger the face image capture. For example, phone 100 may enable the shaking the phone, tilting, moving abruptly, etc. to trigger the capture of the image. Other ways to trigger the face image capture are possible.

In one embodiment, phone 100 may define an emoticon derived from the captured image. In general, an emoticon may include any small graphic that shows an expression of a face. For example, phone 100 may render an emoticon as a thumbnail image of the user's face. Some emoticons may show more than just a face such as including all or part of a head, neck, shoulders, etc. In one embodiment, phone 100 may render an emoticon as a cartoon version of the user's face.

In one embodiment, phone 100 may enable the user to modify image 122 prior to, concurrent with, or after capturing a face image. In one embodiment, phone 100 may enable the user to use gestures to modify image 122. For example, user may use a finger to draw a smile or frown on his or her face either prior to, concurrent with, or after face image capture.

In block 306, phone 100 generates an image indicator in association with the message. In one embodiment, phone 100 may append the image indicator in the message based on the location of a cursor (e.g., element 114 of FIG. 1B) in the message. In one embodiment, the image indicator may include data to be processed as American Standard Code for Information Interchange (ASCII) characters or any other suitable format such as a graphic format for any particular protocol (e.g., for a Short Message Service (SMS) protocol).

The data for the image can be included with the text for the message or the image data can be provided separate from the text and other message data. For example, the image data can be character, bitmap or other data embedded with a file or file, packets or other data portions whereby those data portions also include character information about the letters and symbols for the text message. Another approach is to have the indicator act as a marker or placeholder for where the image will appear. In this case, the image data can reside separate from the text and other message data such as on a server computer, on the user's or recipient's devices, or in a different physical location. The image data can be a separate file or data structure from the other text message data. The indicator can act as a pointer, reference, or address to the image data location. The indicator can also include other information such as where the image is to be placed, characteristics about the image such as whether the image is to be animated, etc. Other variations are possible.

In block 308, phone 100 may send the text message with the associated image indicator to a recipient such that when the text message is displayed on the recipient's device an emoticon is displayed in association with the text message.

While phone 100 is described as performing the steps as described in the embodiments herein, any suitable component or combination of components of phone 100 may perform the steps described.

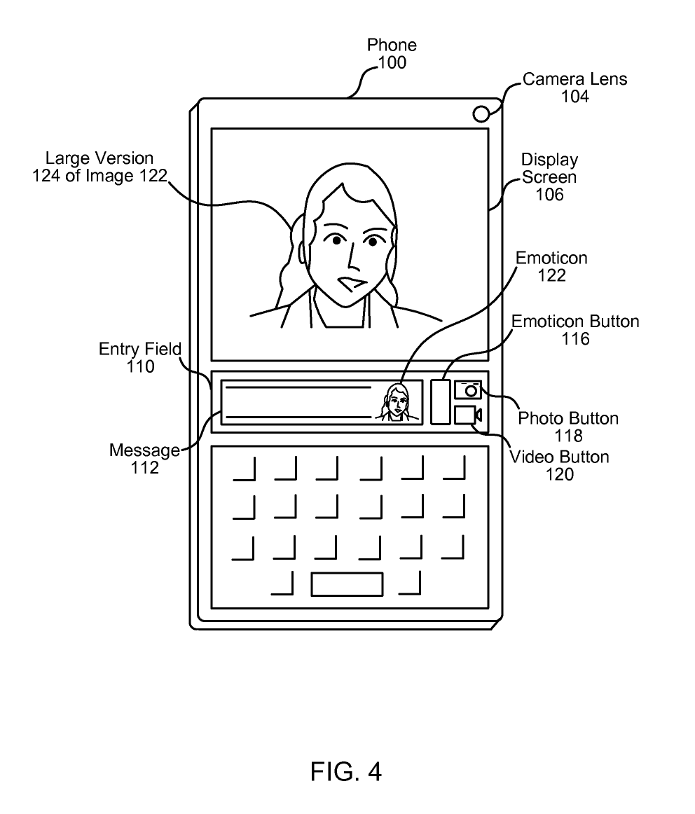

FIG. 4 illustrates a front-view diagram of phone 100 displaying an image 122 after being appended at the cursor location, according to one embodiment. In one embodiment, phone 100 may also display a larger version 124 of image 122 in display screen 106.

As indicated above, to obtain image 122, phone 100 may take a photo or video of the user. For example, user 102 may take a photo or video by looking toward camera lens 104 and then pressing/touching the photo button 118 or video button 120. If taking a video, user presses video button 120 a first time to start recording the video and presses video button 120 a second time to stop recording the video. After capturing image 122, phone 100 stores image 122 in memory such as in memory 204, or in any other suitable memory location.

In one embodiment, phone 100 may automatically crop the image so that a predetermined portion (e.g., a percentage) of the image is a face of the user. For example, if the image is a photo, phone 100 may crop the image such that the photo is 100% face with no background. Other predetermined portions are possible (e.g., 75%, 50%, etc.). In one embodiment, the predetermined portion is set to a default at the factory. In one embodiment, phone 100 enables the user to set or change the predetermined portion. For example, phone 100 may enable the user to enter a percentage in a field or may enable a user to select a percentage using a slide bar control. Once cropped, phone 100 stores the image in memory (e.g., memory 204).

As shown in FIG. 4, phone displays the large version 124 of image 122 on display screen 106. In one embodiment, to approve image 122 for insertion, the user may press/touch emoticon button 116 a second time or may press/touch any other suitable button such as an enter button. Phone 100 receives the user approval and then inserts image 122 at the cursor location.

In one embodiment, phone 100 may already have images of the user stored in a memory location. For example, the user may have already taken one or more photos or videos using phone 100, or the user may have downloaded one or more photos or videos onto phone 100 from another system. Phone 100 may then retrieve the image (e.g., photo or video) from memory 204.

In one embodiment, if multiple stored images are stored locally on phone 100, phone 100 may enable the user to select an image from the pool of available images. In one embodiment, after the user presses emoticon button 116 a first time to initiate the emoticon insertion process, phone 100 may provide the user with a menu of images after phone 100 receives the indication to insert an image of the user into a message. The user may then use the phone controls to toggle to the desired image and then select the desired image. In one embodiment, the user may select the desired image by pressing/touching emoticon button 116 a second time or by pressing/touching another suitable button such as an enter button. Phone 100 receives the selection and then inserts the selected image at the cursor location. In one embodiment, if there are no stored images, phone 100 may prompt the user to take a picture or video so that phone 100 can proceed as described herein.

Phone 100 may store a variety of images of the user, where each image (e.g., photo or video) may represent not only the user, but also a different mood, emotion, or attitude of the user. For example, one image may be of the user smiling, which may indicate that the user is happy. Another image may be of the user laughing, which may indicate that the user is amused or very happy. Another image may be of the user frowning, which may indicate that the user is sad or disappointed. Another image may be a video of the user smiling and jumping up and down, which may indicate that the user is celebratory. The various images may cover a broad range of moods, emotions, and attitudes of the user, and there can be as many variations of images as the user can come up with and capture in photos and/or videos.

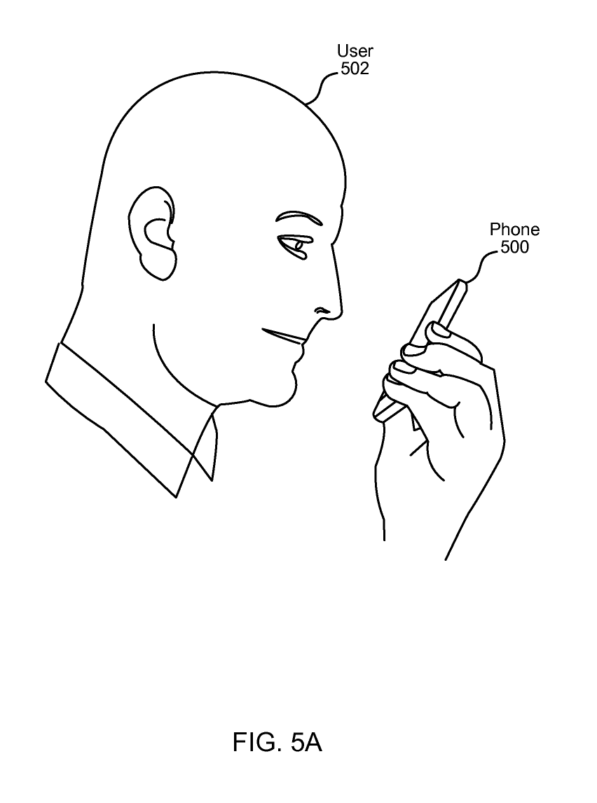

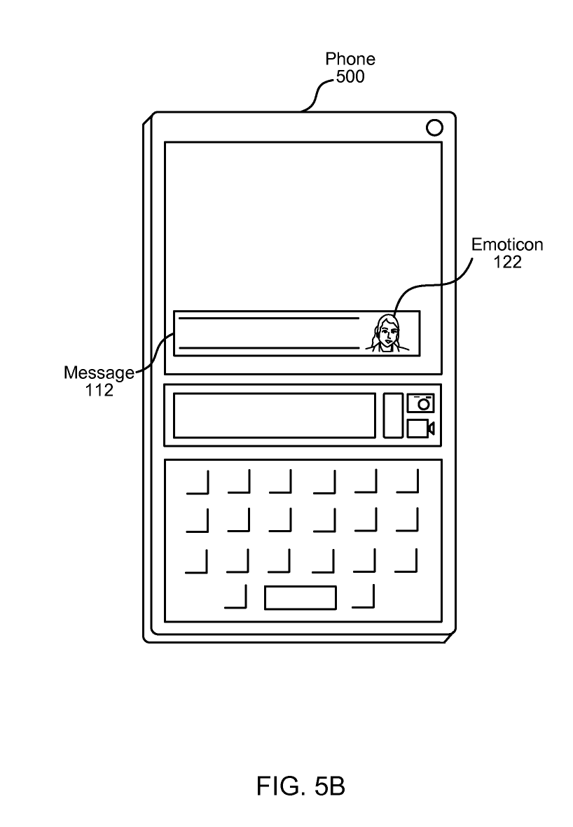

FIG. 5A illustrates a diagram of a phone 500 held by a recipient user 502. FIG. 5B illustrates a front-view diagram of phone 500 displaying a message 504 received from sending user 102, according to one embodiment. As shown, image 122 is inserted in message 112.

In one embodiment, as indicated above, image 122 may be processed as American Standard Code for Information Interchange (ASCII) characters or any other suitable format such as a graphic format for any particular protocol (e.g., for a Short Message Service (SMS) protocol).

Although the description has been described with respect to particular embodiments thereof, these particular embodiments are merely illustrative, and not restrictive.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A method for inserting an emoticon in a text message, wherein a user operates a mobile device to create a text message, the mobile device including a text input interface, camera and user control, the method comprising:
receiving a signal from the text input interface to create the text message;
receiving a signal from the user control to initiate face image capture;
providing an image of the user's face by using the camera in response to the signal from the user control;
defining an emoticon derived from the captured image;
generating an image indicator in association with the text message; and
sending the text message with the associated image indicator so that when the text message is displayed on a recipient's device an emoticon is displayed in association with the text message.

2. The method of claim 1, wherein the providing of the image comprises:
taking a photo of the user; and
storing the photo in a memory location.

3. The method of claim 1, wherein the providing of the image comprises:
taking a video of the user; and
storing the video in a memory location.

4. The method of claim 1, wherein the providing of the image comprises retrieving the image from a storage device.

5. The method of claim 1, wherein the providing of the image comprises enabling the user to select a first image of a plurality of images.

6. The method of claim 1, further comprising cropping the image so that a predetermined portion of the image is a face of the user.

7. The method of claim 1, wherein the text message is composed by one more of the user typing, talking and using speech-to-text conversion, and gesturing and using gesture-to-text conversion.

8. A computer-readable storage medium carrying one or more sequences of instructions thereon, the instructions when executed by a processor cause the processor to:
receive a signal from the text input interface to create the text message;
receive a signal from the user control to initiate face image capture;
provide an image of the user's face by using the camera in response to the signal from the user control;
define an emoticon derived from the captured image;
generate an image indicator in association with the text message; and
send the text message with the associated image indicator so that when the text message is displayed on a recipient's device an emoticon is displayed in association with the text message.

9. The computer-readable storage medium of claim 8, wherein the instructions further cause the processor to:
take a photo of the user; and
store the photo in a memory location.

10. The computer-readable storage medium of claim 8, wherein the instructions further cause the processor to:
take a video of the user; and
store the video in a memory location.

11. The computer-readable storage medium of claim 8, wherein the instructions further cause the processor to retrieve the image from a storage device.

12. The computer-readable storage medium of claim 8, wherein the instructions further cause the processor to enable the user to select a first image of a plurality of images.

13. The computer-readable storage medium of claim 8, wherein the instructions further cause the processor to crop the image so that a predetermined portion of the image is a face of the user.

14. The computer-readable storage medium of claim 8, wherein the text message is composed by one more of the user typing, talking and using speech-to-text conversion, and gesturing and using gesture-to-text conversion.

15. An apparatus comprising:
one or more processors; and
logic encoded in one or more tangible media for execution by the one or more processors, and when executed operable to:
receive a signal from the text input interface to create the text message;
receive a signal from the user control to initiate face image capture;
provide an image of the user's face by using the camera in response to the signal from the user control;
define an emoticon derived from the captured image;
generate an image indicator in association with the text message; and
send the text message with the associated image indicator so that when the text message is displayed on a recipient's device an emoticon is displayed in association with the text message.

16. The apparatus of claim 15, wherein the logic when executed is further operable to:
take a photo of the user; and
store the photo in a memory location.

17. The apparatus of claim 15, wherein the logic when executed is further operable to:
take a video of the user; and
store the video in a memory location.

18. The apparatus of claim 15, wherein the logic when executed is further operable to select a first image of a plurality of images.

19. The apparatus of claim 15, wherein the logic when executed is further operable to crop the image so that a predetermined portion of the image is a face of the user.

20. A method, for capturing an image of a user typing a text message and inserting the image into the text message, the method comprising:
receiving a first signal from a user input device to define text in a text message that the user is typing;
receiving a second signal from a user input device to indicate that the user is selecting image insertion;
providing an image of the user in response to the second signal;
inserting the captured image into the text message; and
sending the text message along with the captured image for display of the text message along with the image to an intended recipient.
